(19) United States
(12) Patent Application Publication
(10) Pub. No.: US 2012/0090002 A1
(43) Pub. Date: Apr. 12, 2012

(54) DIGITAL BROADCAST RECEPTION DEVICE AND DIGITAL BROADCAST RECEPTION METHOD

(75) Inventors: Ryo Yokoyama, Kanagawa (JP); Toshio Oka, Kanagawa (JP); Masaki Takahashi, Tokyo (JP)

(73) Assignee: Panasonic Corporation, Osaka (JP)

(21) Appl. No.: 13/377,265

(22) PCT Filed: Apr. 23, 2010
(86) PCT No.: PCT/JP2010/002955

§ 371 Date: Dec. 9, 2011

(30) Foreign Application Priority Data
Jun. 12, 2009 (JP) 2009-141290

(51) Int. Cl. H04N 5/44

(52) U.S. Cl. 725/37

(57) ABSTRACT

Disclosed are a digital broadcast reception device and digital broadcast reception method which can quickly present a data broadcast presentation screen once a user instructs that data broadcast be presented. The digital broadcast reception device (100) is provided with a screen holding unit (114) which stores pictures (bitmaps) of data broadcast presentation screens created by a browser unit (112), and a video position information holding unit (115) which stores position information for displaying TV video on the data broadcast presentation screen generated by the browser unit (112). When a data broadcast presentation request is received from the user, a layout control unit (113) first displays a data broadcast presentation screen comprised of a combination of a bitmap of a data broadcast presentation screen stored in the screen holding unit (114) and position information stored in the video position information holding unit (115), then, the browser unit (112) switches the screen to a data broadcast presentation screen created after the data broadcast presentation request was received from the user.

### TECHNICAL FIELD

The present invention relates to a digital broadcast reception apparatus and digital broadcast reception method capable of receiving digital broadcasting.

### BACKGROUND ART

In digital broadcasting, data broadcast services are performed in addition to TV broadcasting by means of video and audio and audio broadcast services. Data broadcast services refer to all services that include, apart from TV broadcasting, an EPG (Electronic Program Guide) or captions, subtitles, downloads, and multimedia broadcast services. A multimedia broadcast service will be described here.

A multimedia broadcast service (hereinafter referred to as data broadcasting) broadcasts information configured by combining text, graphics, still images, video, audio, and suchlike individual representational media. A digital broadcast reception apparatus performs ongoing control of information presentation by performing display playback through combinational control of these representational media, selecting information in accordance with remote control operations by a viewer, and so forth.

FIG. 1 is a drawing showing an example of a data broadcast presentation screen.

As shown in FIG. 1, data broadcast presentation screen 1 has TV broadcast screen 2 within the data broadcast presentation screen, and various kinds of information 3 through 9 presented by means of data broadcasting.

TV broadcast screen 2 within the data broadcast presentation screen is displayed reduced in size compared with a case in which a TV broadcast service is used.

Various kinds of information 3 through 9 include, for example, news, weather forecasts, and images.

Data broadcast data is written in BML (Broadcast Markup Language). BML stipulated by ARIB STD-B24 is an XML (Extensible Markup Language) application language, and incorporates an XHTML standard tag set in which HTML (Hypertext Markup Language) specifications are rewritten based on XML as a tag basic set. BML uses CSS (Cascading Style Sheets) as style sheets for display control. A part relating to data broadcast display, that is, spatial layout, can be set by means of these tag and style sheet specifications.

BML uses the ECMA (European Computer Manufacturer Association) Script and DOM (Document Object Mode) standard to describe operation control of multimedia information corresponding to interactive operations such as redrawing a displayed figure by means of a remote control or suchlike operation. ECMA Script is a script language used for procedure descriptions. DOM specifies an interface for manipulating a BML document. By changing the value of contents or an attribute of each element in a BML document by manipulating that value by means of ECMA Script via DOM, the result appears with its display contents changed.

FIG. 2 is a drawing for explaining data broadcast data written in BML.

As shown in FIG. 2, data broadcast data 11 written in BML comprises header part 12, style sheet part 13, ECMA Script part 14, body element front part 15, TV video display position and size specification 16, JPEG file display position and size specification 17, and remote control setting button 18.

Header part 12 represents data written in BML.

Style sheet part 13 here specifies a background color.

ECMA Script part 14 stipulates a function, and executes the described processing part when the function is called.

Body element front part 15 represents actual data contents.

TV video display position and size specification 16 specifies the display position and size of TV video. The TV video specified by TV video display position and size specification 16 is TV broadcast screen 2 in FIG. 1.

JPEG file display position and size specification 17 specifies the display position and size of a JPEG file. A JPEG image specified by TV video display position and size specification 16 is information of various kinds 3 in FIG. 1.

Remote control setting button 18 is a remote control setting button that represents information of various kinds 6 in FIG. 1. When a user selects information of various kinds 6, the function written in ECMA Script part 14 above is called. In this way, a data broadcast presentation screen is configured in accordance with a BML description.

The above data broadcast data is transmit in accordance with a data carousel transmission method.

A data carousel transmission method is a content transmission method in a data download or multimedia service based on the ISO/IEC13818-6 DSM-CC data carousel specification, stipulated by ARIB STD-B24 (a standard relating to a data broadcast encoding method and transmission method in digital broadcasting formulated by the Association of Radio Industries and Businesses). In this data carousel transmission method, download module related information called a DII (Download Info Indication) and a download module itself called a DDB (Download Data Block) are repeatedly transferred by means of a structure called a DSM-CC section.

When a user receives a digital broadcast data broadcast service, a digital broadcast reception apparatus extracts data broadcast data from a TS (Transport Stream) and processes it, and after presentation preparations have been performed, presents a processed data broadcast service. However, the sending frequency of each data transmitted with respect to a carousel cycle is not constant, and depending on the service contents, a considerable amount of time (hereinafter referred to as data acquisition time) may be required before a digital broadcast reception apparatus completes acquisition of data necessary for presentation.

Also, a conventional digital broadcast reception apparatus needs to analyze a BML document included in acquired data in order to present the contents of that data. The time required for this analysis may also be considerable before data broadcast display. In the case of a BML document with a large content capacity, in particular, a conventional digital broadcast reception apparatus requires a considerable amount of time for analysis, and requires a considerable amount of time until drawing is performed (hereinafter referred to as analysis/drawing time).

In Patent Literature 1, data broadcast data is received and stored in a database before a user specifies a data broadcast service. When the user subsequently specifies a service, data broadcast data is acquired from a locally created database and displayed on a screen. The apparatus described in Patent Literature 1 attempts to reduce the above-described data acquisition time and shorten the time until a data broadcast is presented by storing data broadcast data transmitted in accordance with a carousel method in a locally created database.

### CITATION LIST

### Patent Literature

### PTL 1

### Japanese Patent Application Laid-Open No. 2003-51754

### SUMMARY OF INVENTION

### Technical Problem

However, the digital broadcast reception apparatus described in Patent Literature 1 shortens the above data acquisition time, but is not intended to shorten the above analysis/drawing time. That is to say, data broadcast data written in BML is analyzed, but the problem of the time required until drawing remains unresolved. In particular, if an initially presented document (startup document) is of large capacity, a considerable amount of time is required until the startup document BML is analyzed.

It is an object of the present invention to provide a digital broadcast reception apparatus and digital broadcast reception method that enable a data broadcast presentation screen to be presented quickly after a user gives an instruction for data broadcast presentation.

### Solution to Problem

A digital broadcast reception apparatus of the present invention is capable of receiving a data broadcast, and employs a configuration having: a browser section that creates a data broadcast service presentation screen from data broadcast data; a screen holding section that stores a picture of a data broadcast presentation screen created by the browser section; a video position information holding section that stores position information for displaying TV video in a data broadcast presentation screen created by the browser section; and a layout control section that, when a data broadcast presentation request is received from a user, first displays a data broadcast presentation screen combining a picture of a data broadcast presentation screen stored in the screen holding section and position information stored in the video position information holding section, and then switches display to a data broadcast presentation screen created by the browser section after receiving a data broadcast presentation request from the user.

A digital broadcast reception method of the present invention receives a data broadcast, and has: a step of creating a data broadcast service presentation screen from data broadcast data at predetermined update timing; a step of storing a picture of a created data broadcast presentation screen; a step of storing position information for displaying TV video in a created data broadcast presentation screen; and a step of, when a data broadcast presentation request is received from a user, first displaying a data broadcast presentation screen combining the data broadcast presentation screen picture and position information stored prior to that data broadcast presentation request, and then switching display to a data broadcast presentation screen created after receiving that data broadcast presentation request.

### Advantageous Effects of Invention

The present invention enables the time for analyzing and drawing data broadcast data written in BML to be shortened, and enables a data broadcast presentation screen to be displayed quickly after a user gives an instruction for data broadcast presentation.

### BRIEF DESCRIPTION OF DRAWINGS

FIG. 1 is a drawing showing an example of a data broadcast presentation screen of a conventional digital broadcast reception apparatus;

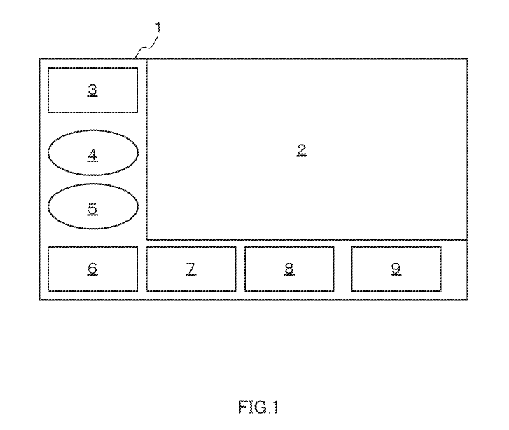

FIG. 2 is a drawing for explaining data broadcast data written in BML;

FIG. 3 is a block diagram showing the configuration of a digital broadcast reception apparatus according to Embodiment 1 of the present invention;

FIG. 4 is a flowchart showing layout control processing performed by a layout control section of a digital broadcast reception apparatus according to above Embodiment 1;

FIG. 5 is a flowchart showing processing performed by a BML data management section of a digital broadcast reception apparatus according to above Embodiment 1;

FIG. 6 is a drawing showing per-time changes for a data broadcast presentation screen provided by a digital broadcast reception apparatus according to above Embodiment 1;

FIG. 7 is a block diagram showing the configuration of a digital broadcast reception apparatus according to Embodiment 2 of the present invention;

FIG. 8 is a drawing for explaining an example of data reconfigured by a BML data extraction section of a digital broadcast reception apparatus according to above Embodiment 2;

FIG. 9 is a flowchart showing layout control processing performed by a layout control section of a digital broadcast reception apparatus according to above Embodiment 2;

FIG. 10 is a block diagram showing the configuration of a digital broadcast reception apparatus according to Embodiment 3 of the present invention; and

FIG. 11 is a flowchart showing data update determination processing performed by a BML data update determination section of a digital broadcast reception apparatus according to above Embodiment 3.

### DESCRIPTION OF EMBODIMENTS

Now, embodiments of the present invention will be described in detail with reference to the accompanying drawings.

### Embodiment 1

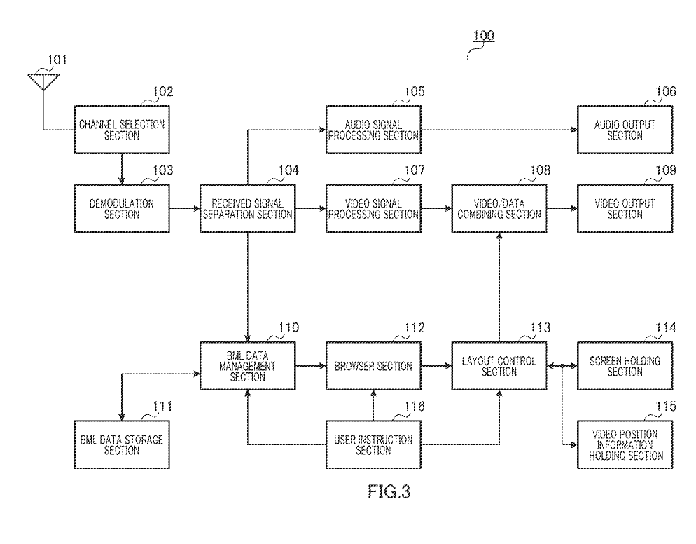

FIG. 3 is a block diagram showing the configuration of a digital broadcast reception apparatus according to Embodiment 1 of the present invention.

As shown in FIG. 3, digital broadcast reception apparatus 100 is provided with antenna section 101, channel selection section 102, demodulation section 103, received signal separation section 104, audio signal processing section 105, audio output section 106, video signal processing section 107, video/data combining section 108, video output section 109, BML data management section 110, BML data storage section 111, browser section 112, layout control section 113, screen holding section 114, video position information holding section 115, and user instruction section 116.

Antenna section 101 receives digital broadcast waves transmitted from broadcasting stations, and supplies received digital broadcast signals to channel selection section 102.

Channel selection section 102 selects a digital broadcast signal from a broadcasting station a user wishes to view from among the received digital broadcast signals, and transmits the selected digital broadcast signal to demodulation section 103.

Demodulation section 103 converts the digital broadcast signal selected by channel selection section 102 to an MPEG-TS signal, and transmits this signal to received signal separation section 104.

Received signal separation section 104 separates an MPEG-TS signal sent from demodulation section 103 into an audio signal, a video signal, and data broadcast data, and transmits these to audio signal processing section 105, video signal processing section 107, and BML data management section 110, respectively.

Audio signal processing section 105 decodes an audio signal separated by received signal separation section 104, and transmits a decoded audio signal to audio output section 106.

Audio output section 106 outputs audio decoded by audio signal processing section 105.

Video signal processing section 107 decodes a video signal sent by received signal separation section 104, and transmits a decoded video signal to video/data combining section 108.

Video/data combining section 108 combines video decoded by video signal processing section 107 with a data broadcast presentation screen sent by layout control section 113 and so forth, and transmits the result to video output section 109.

Video output section 109 outputs video received by video/data combining section 108.

BML data management section 110 manages data broadcast data and data broadcast data stored in BML data storage section 111. BML data management section 110 switches between data broadcast data stored in BML data storage section 111 and data broadcast data separated from a newly received digital broadcast wave, and sends data to browser section 112. Specifically, BML data management section 110 receives data broadcast data from received signal separation section 104, and sends that data to BML data storage section 111. Also, BML data management section 110 transmits startup document data to browser section 112. Furthermore, if there is a data broadcast presentation request from a user from user instruction section 116, BML data management section 110 transmits data broadcast data stored by BML data storage section 111 or data broadcast data received from received signal separation section 104 to browser section 112.

BML data storage section 111 stores data broadcast data separated from a digital broadcast wave in accordance with an instruction from BML data management section 110. Also, if there is a request from BML data management section 110, BML data storage section 111 transmits stored data broadcast data to BML data management section 110.

Browser section 112 creates a data broadcast service presentation screen from data broadcast data. Browser section 112 analyzes BML data received from BML data management section 110, and transmits a created data broadcast presentation screen, and information indicating the display position of TV video in the data broadcast presentation screen (hereinafter referred to as video position information), to layout control section 113. Also, if there is a remote control operation request by a user from user instruction section 116, browser section 112 executes the relevant browsing processing.

Layout control section 113 switches between a picture (bitmap) of a data broadcast presentation screen stored by screen holding section 114 and a data broadcast presentation screen created by browser section 112. Upon receiving a browser presentation screen and video position information from browser section 112, layout control section 113 transmits the browser presentation screen to screen holding section 114, and transmits the video position information to video position information holding section 115. If there is a data broadcast presentation request from user instruction section 116, the browser presentation screen is also transmitted to video/data combining section 108. Also, if there is a data broadcast presentation request from user instruction section 116, and nothing has been received from browser section 112, layout control section 113 receives a browser presentation screen bitmap from screen holding section 114, receives video position information from video position information holding section 115, and transmits these to video/data combining section 108.

At this time, video/data combining section 108 changes the size of video received from the video signal processing section in accordance with video position information transmitted from layout control section 113, and combines it with the browser presentation screen transmitted from layout control section 113.

That is to say, when a data broadcast presentation request has been received from the user, layout control section 113 first displays a data broadcast presentation screen combining a data broadcast presentation screen picture (bitmap) stored in screen holding section 114 and position information stored in video position information holding section 115, and then switches display to a data broadcast presentation screen created by browser section 112 after receiving a data broadcast presentation request from the user.

Screen holding section 114 stores bitmap information of a browser presentation screen transmitted by layout control section 113. Specifically, screen holding section 114 stores a picture (bitmap) of a data broadcast presentation screen created by browser section 112. Screen holding section 114 also transmits stored browser presentation screen bitmap information to layout control section 113 in response to a request from layout control section 113.

Video position information holding section 115 stores video position information transmitted by layout control section 113. Specifically, video position information holding section 115 stores position information for displaying TV video in a data broadcast presentation screen created by browser section 112. Video position information holding section 115 also transmits stored video position information to layout control section 113 in response to a request from layout control section 113.

The operation of digital broadcast reception apparatus 100 configured as described above will now be explained.

First, layout control processing performed by layout control section 113 will be described.

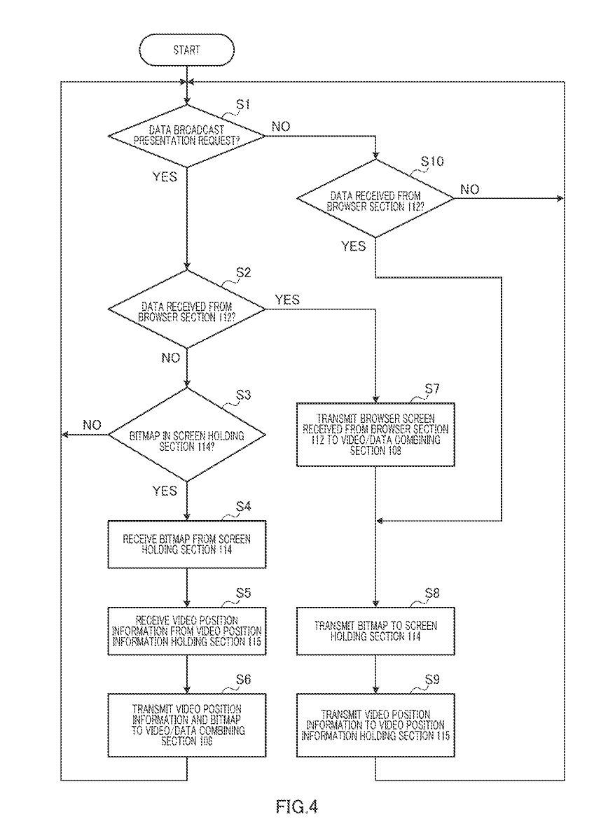

FIG. 4 is a flowchart showing layout control processing performed by layout control section 113. This processing flow is executed repeatedly at predetermined timing. In the flowchart, “S” indicates a step of the processing flow.

First, in step S1, layout control section 113 checks whether or not there is a data broadcast presentation request input from user instruction section 116.

If there is a data broadcast presentation request, in step S2 layout control section 113 checks whether or not data has been received from browser section 112.

If data has not been received from browser section 112, in step S3 layout control section 113 checks whether or not a data broadcast presentation screen picture (bitmap) is stored in screen holding section 114. If there is no bitmap, the processing flow returns to above step S1.

If there is a bitmap, in step S4 layout control section 113 receives the data broadcast presentation screen bitmap from screen holding section 114.

In step S5, layout control section 113 receives video position information from video position information holding section 115.

In step S6, layout control section 113 transmits the received bitmap and video position information to video/data combining section 108. Video/data combining section 108 uses this information to create a data broadcast presentation screen.

If data has been received from browser section 112 in step S2, in step S7 layout control section 113 transmits a data broadcast presentation screen received from browser section 112 to video/data combining section 108.

In step S8, layout control section 113 transmits a picture of a data broadcast presentation screen received from browser section 112 to screen holding section 114 as a bitmap.

In step S9, layout control section 113 transmits video position information received from browser section 112 to video position information holding section 115, and returns to above step S1.

If there is no data broadcast presentation request from the user in step S1, in step S10 layout control section 113 checks for data reception from browser section 112.

If data has been received from the browser, the processing flow proceeds to step S8. That is to say, layout control section 113 performs preparations for storing a data broadcast presentation screen picture and video position information without transmitting a data broadcast presentation screen to video/data combining section 108. On the other hand, if data has not been received from browser section 112, the processing flow returns to above step S1.

Next, BML data management section 110 processing will be described.

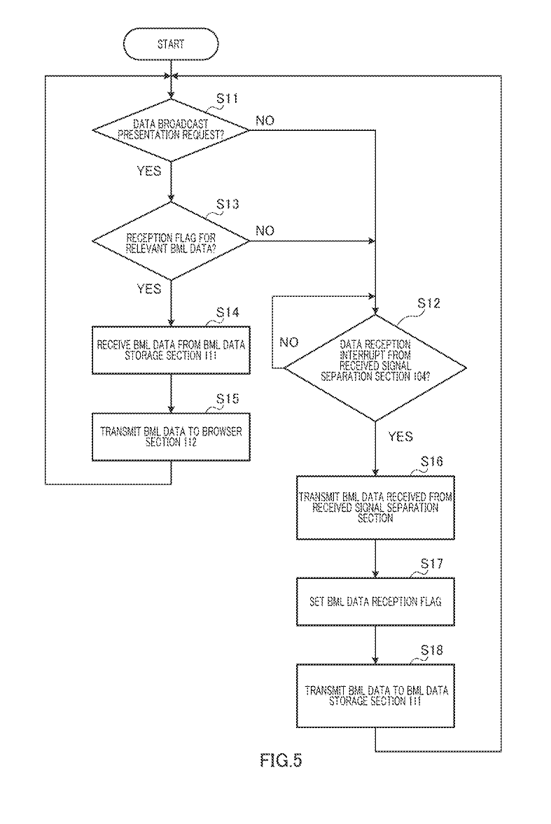

FIG. 5 is a flowchart showing processing performed by BML data management section 110.

First, in step S11, BML data management section 110 checks whether or not there is a data broadcast presentation request from layout control section 113.

If there is no data broadcast presentation request, in step S12 BML data management section 110 waits for a data broadcast data reception interrupt from received signal separation section 104.

If there is a data broadcast presentation request, in step S13 BML data management section 110 checks whether or not there is a reception flag indicating that relevant data is stored in BML data storage section 111.

If there is no reception flag, the processing flow proceeds to step S12.

If there is a reception flag in step S13, that is, if relevant data broadcast data is stored in BML data storage section 111, in step S14 BML data management section 110 receives the relevant data broadcast data from BML data storage section 111.

In step S15, BML data management section 110 transmits data broadcast data received from data broadcast data 11 to browser section 112, and returns to step S11.

If there is a data reception interrupt from received signal separation section 104 in above step S12, in step S16 BML data management section 110 transmits data broadcast data received from received signal separation section 104 to browser section 112.

In step S17, BML data management section 110 sets a reception flag for the relevant data. For example, in the case of a startup document, BML data management section 110 sets a component tag 0×40 data reception flag.

In step S18, BML data management section 110 transmits data broadcast data received from received signal separation section 104 to BML data storage section 111 in order to store that data in BML data storage section 111, and returns to step S11.

Next, a description will be given of the data broadcast presentation screen time sequence when data broadcast presentation is requested by a user.

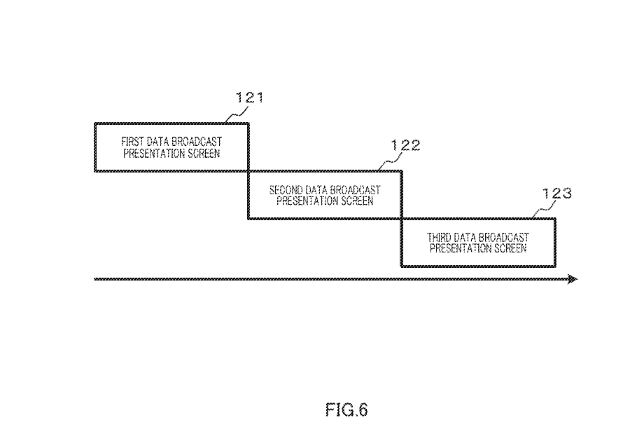

FIG. 6 is a drawing showing per-time changes for a data broadcast presentation screen provided by digital broadcast reception apparatus 100.

When data broadcast presentation is requested by a user, digital broadcast reception apparatus 100 provides the user with first data broadcast presentation screen 121, second data broadcast presentation screen 122, and third data broadcast presentation screen 123 in turn.

First data broadcast presentation screen 121 is a data broadcast presentation screen displayed by changing the video size and display position according to a bitmap stored in screen holding section 114 and TV video position information in video position information holding section 115 in accordance with step S6 in FIG. 4. Displaying a stored bitmap enables the user to be provided with a data broadcast presentation screen promptly.

Second data broadcast presentation screen 122 is a data broadcast presentation screen created by browser section 112 from BML data stored in BML data storage section 111 in accordance with steps S14 and S15 in FIG. 5.

Third data broadcast presentation screen 123 is the latest data broadcast presentation screen created by browser section 112 from data broadcast data newly transmitted from received signal separation section 104 in accordance with step S16 in FIG. 5.

By switching between the display of three data broadcast presentation screens sequentially in this way, digital broadcast reception apparatus 100 can quickly provide a user with a data broadcast screen after the user gives an instruction for data broadcast presentation.

As described in detail above, according to this embodiment, digital broadcast reception apparatus 100 is provided with screen holding section 114 that stores a picture (bitmap) of a data broadcast presentation screen created by browser section 112, and video position information holding section 115 that stores video position information transmitted by layout control section 113. Specifically, video position information holding section 115 stores position information for displaying TV video in a data broadcast presentation screen created by browser section 112. When a data broadcast presentation request is received from the user, layout control section 113 first displays a data broadcast presentation screen combining a data broadcast presentation screen bitmap stored in screen holding section 114 and position information stored in video position information holding section 115. Subsequently, layout control section 113 switches display to a data broadcast presentation screen created by browser section 112 after receiving a data broadcast presentation request from the user.

That is to say, prior to a user instruction, layout control section 113 analyzes a procedure description language part at predetermined update timing, creates a data broadcast presentation screen bitmap, and stores this in screen holding section 114, and also stores position information for performing TV video display of this bitmap in video position information holding section 115.

Then, upon receiving a data broadcast presentation instruction, layout control section 113 first displays the previously held data broadcast presentation screen bitmap in the relevant TV video display position. Subsequently, layout control section 113 switches display to a data broadcast presentation screen created by browser section 112 after receiving a data broadcast presentation request from the user.

Here, if there is no change prior to a data broadcast presentation request from the user as a result of analysis of the procedure description language part, the current data broadcast presentation screen bitmap continues to be displayed in the relevant TV video display position. Since a previously analyzed and stored data broadcast presentation screen bitmap is displayed virtually simultaneously with a user's data broadcast presentation instruction, the user can receive an impression of a data broadcast screen being displayed quickly, with almost no delay, after giving an instruction for data broadcast presentation.

In an example of conventional technology, a considerable amount of time (for example, about three seconds) is required to analyze data broadcast data written in BML before drawing is performed. In particular, if a document presented initially when data broadcasting is started (a startup document) is of large capacity, a considerable amount of time is required to analyze the BML of the startup document. In contrast, in this embodiment, a data broadcast presentation screen bitmap is displayed virtually simultaneously with a user's data broadcast presentation instruction, enabling the user to view a data broadcast screen quickly, with almost no delay, while also allowing the latest browser screen to be configured by means of background processing, so to speak, using this interval.

### Embodiment 2

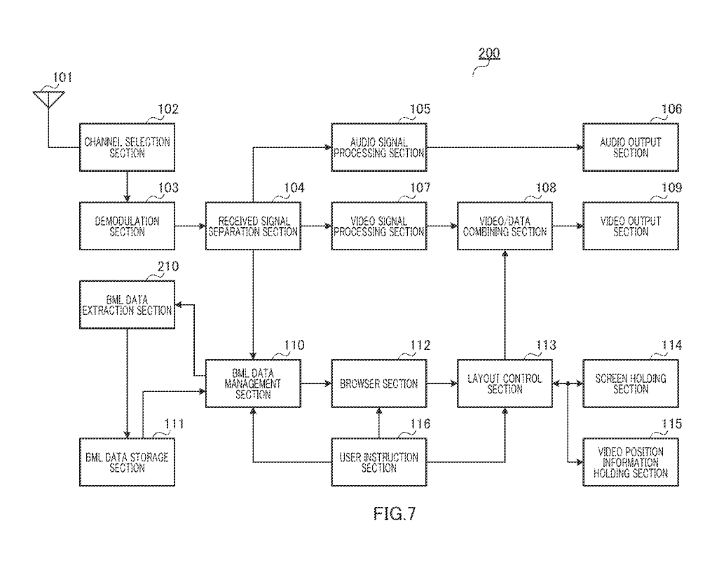

FIG. 7 is a block diagram showing the configuration of a digital broadcast reception apparatus according to Embodiment 2 of the present invention. Configuration parts identical to those in FIG. 3 are assigned the same reference codes as in FIG. 3, and duplicate descriptions thereof are omitted here.

As shown in FIG. 7, digital broadcast reception apparatus 200 is provided with antenna section 101, channel selection section 102, demodulation section 103, received signal separation section 104, audio signal processing section 105, audio output section 106, video signal processing section 107, video/data combining section 108, video output section 109, BML data management section 110, BML data extraction section 210, BML data storage section 111, browser section 112, layout control section 113, screen holding section 114, video position information holding section 115, and user instruction section 116.

In digital broadcast reception apparatus 200, BML data extraction section 210 is additionally connected between BML data management section 110 and the BML data holding section in digital broadcast reception apparatus 100 in FIG. 3.

BML data extraction section 210 extracts only a procedure description language part from data broadcast data, and reconfigures data broadcast data based on the extracted procedure description language part. Specifically, BML data extraction section 210 extracts EDMA Script and DOM, excluding a part configuring a presentation screen layout, from within data received from BML data management section 110, and reconfigures data broadcast data. BML data extraction section 210 transmits the reconfigured data to BML data storage section 111. BML data storage section 111 stores the reconfigured data broadcast data.

BML data management section 110 switches between reconfigured data broadcast data stored in BML data storage section 111 and data broadcast data separated from a newly received digital broadcast wave, and sends data to browser section 112.

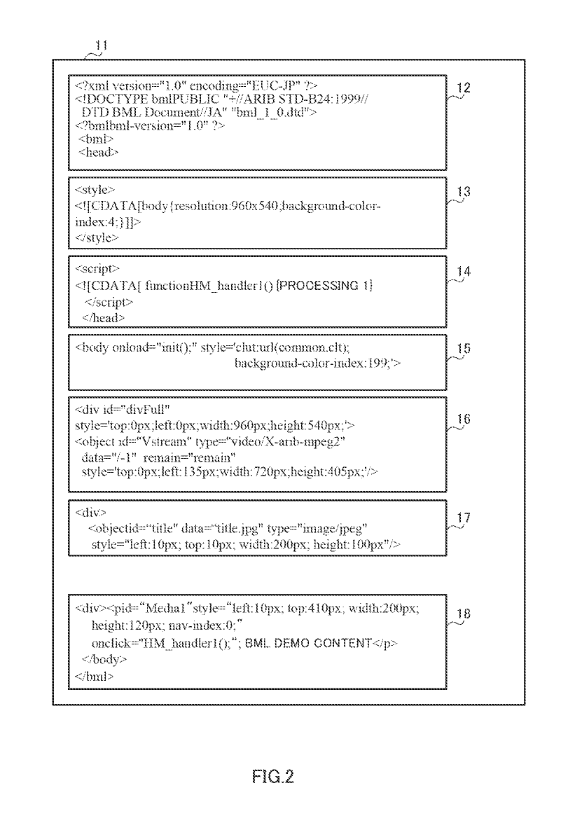

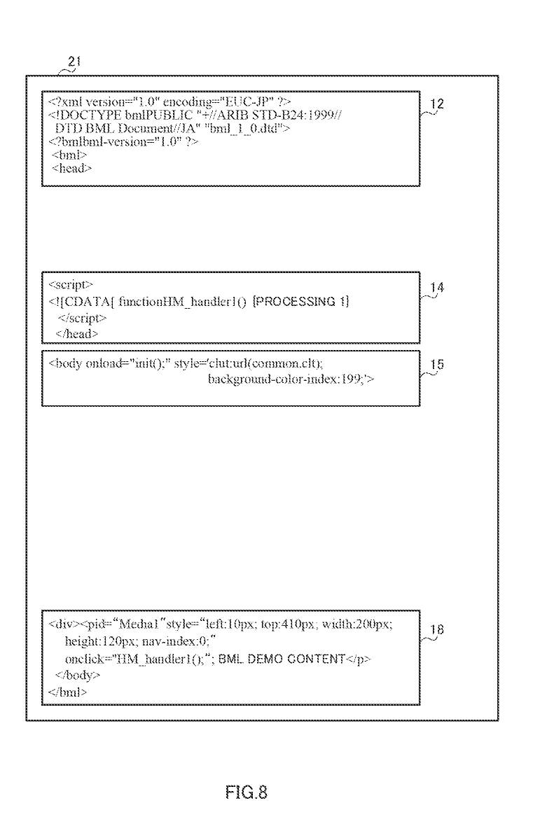

FIG. 8 is a drawing for explaining an example of data reconfigured from the data in FIG. 2 by BML data extraction section 210. Data examples identical to those in FIG. 2 are assigned the same reference codes as in FIG. 2.

As shown in FIG. 8, of data broadcast data 11 in FIG. 2, data 21 reconfigured by BML data extraction section 210 comprises header part 12, ECMA Script part 14, body element front part 15, and remote control setting button 18, and omits style sheet part 13 specifying the background color, size specification 16 specifying the TV video display position and size, and display position and size specification 17 specifying the JPEG file display position and size. Thus, data 21 is reconfigured with parts configuring the data broadcast presentation screen layout omitted.

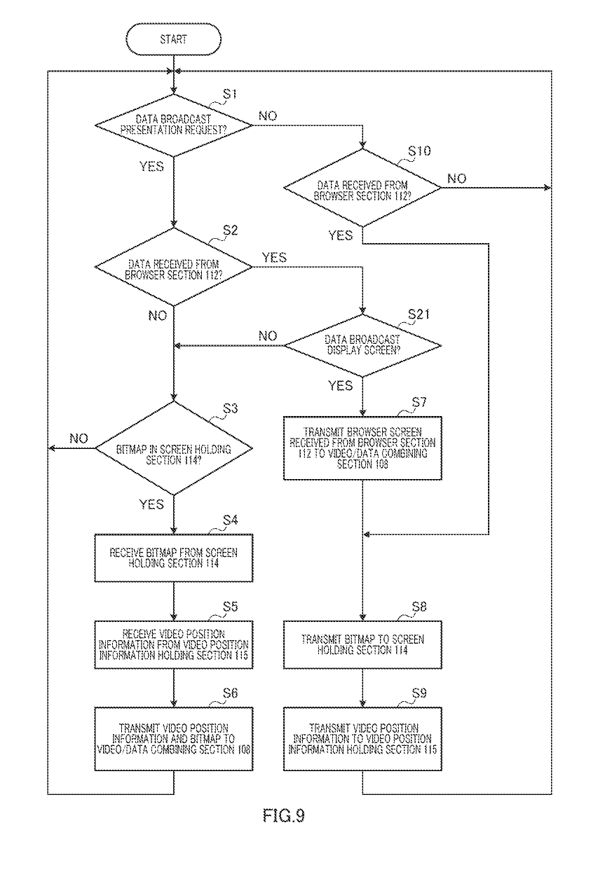

FIG. 9 is a flowchart showing layout control processing performed by layout control section 113. Steps in which the same processing is performed as in the flowchart in FIG. 4 are assigned the same reference codes as in FIG. 4, and descriptions thereof are omitted here.

As shown in FIG. 9, if data has been received from browser section 112 in step S2, the processing flow proceeds to step S21.

In step S21, layout control section 113 determines whether or not there is a data broadcast display screen. If there is no data broadcast presentation screen in the received data, that is, if data created by browser section 112 comprises only procedure description language parts such as EDMA Script and DOM, the processing flow proceeds to step S3.

On the other hand, if there is data broadcast presentation screen layout information in step S21, that is, if data created by browser section 112 is separated data broadcast data output from received signal separation section 104, the processing flow proceeds to step S7. BML data extraction section 210 extracts only procedure description language parts such as EDMA Script and DOM from the data broadcast data, and reconfigures the data broadcast data.

Browser section 112 creates BML data of only procedure description language parts excluding parts configuring a presentation screen by means of BML data extraction section 210. Since browser section 112 performs creation from BML data of only procedure description language parts, a user remote control operation can be effected more quickly than when creation is performed from all BML data.

By creating data and providing the user with a data broadcast presentation screen, browser section 112 becomes able to accept key operations from the user.

When the user requests data broadcast presentation, that is, when a data broadcast presentation request is issued to layout control section 113 and data management section 110 from user instruction section 116, a data broadcast presentation screen created from a bitmap stored in screen holding section 114 and video position information stored in video position information holding section 115 is first displayed in accordance with step S6. Displaying a stored bitmap enables the user to be provided with a data broadcast presentation screen promptly.

By switching between the display of three data broadcast presentation screen states sequentially in this way, digital broadcast reception apparatus 200 can quickly provide a user with data broadcast service after the user requests data broadcast presentation.

### Embodiment 3

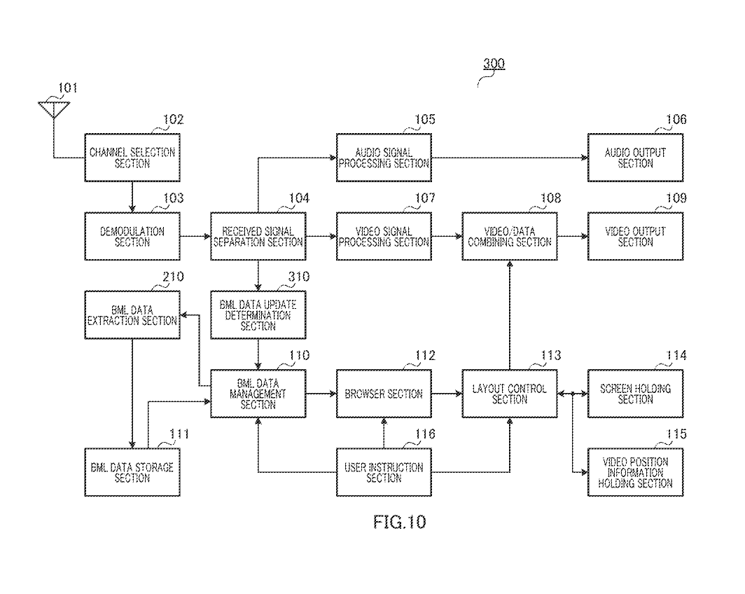

FIG. 10 is a block diagram showing the configuration of a digital broadcast reception apparatus according to Embodiment 3 of the present invention. Configuration parts identical to those in FIG. 7 are assigned the same reference codes as in FIG. 7, and duplicate descriptions thereof are omitted here.

As shown in FIG. 10, digital broadcast reception apparatus 300 is provided with antenna section 101, channel selection section 102, demodulation section 103, received signal separation section 104, audio signal processing section 105, audio output section 106, video signal processing section 107, video/data combining section 108, video output section 109, BML data management section 110, BML data update determination section 310, BML data extraction section 210, BML data storage section 111, browser section 112, layout control section 113, screen holding section 114, video position information holding section 115, and user instruction section 116.

In digital broadcast reception apparatus 300, BML data update determination section 310 is additionally connected between received signal separation section 104 and BML data management section 110 in digital broadcast reception apparatus 200 in FIG. 7.

Received signal separation section 104 transmits BML data that is data broadcast data to BML data update determination section 310.

BML data management section 110 receives a BML data reception interrupt from BML data update determination section 310.

BML data update determination section 310 determines whether or not data broadcast data separated from a digital broadcast is the latest, and if the data broadcast data is the latest, transmits the data broadcast data to BML data management section 110.

BML data update determination section 310 is provided internally with a database that stores a component tag value identifying a BML document, a date_event_id value in DII and DDB, and a DII module_version value. By referencing this database, BML data update determination section 310 determines whether BML data received from received signal separation section 104 is BML data already stored in BML data storage section 111, or is new BML data.

In the event of determining BML data to be new BML data, that is, in the event of determining that BML data is data that is not already stored in BML data storage section 111, BML data update determination section 310 transmits the BML data to BML data management section 110. On the other hand, in the event of determining that BML data is BML data that is already stored in BML data storage section 111, BML data update determination section 310 discards that BML data.

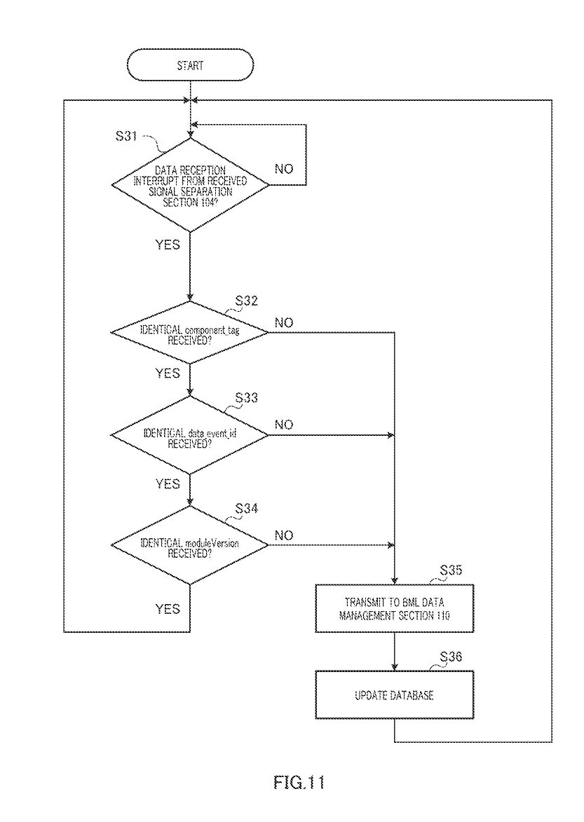

FIG. 11 is a flowchart showing data update determination processing performed by BML data update determination section 310.

First, in step S31, BML data update determination section 310 enters a state of waiting for a BML data reception interrupt from received signal separation section 104.

When there is a reception interrupt from received signal separation section 104, in step S32 BML data update determination section 310 reads a Component_tag of received BML data, references the above database, and determines whether or not that data has already been received. If there is a reception record for the received BML data in the above database, that is, if the received BML data has already been received, the processing flow proceeds to step S33. On the other hand, if there is no reception record for the received BML data in the database and the received BML data is new data, the processing flow proceeds to step S35.

In step S33, BML data update determination section 310 reads a DDI or DDB data_event_id of the received BML data, references the above database, and determines whether or not that data has already been received. If there is a reception record for the received BML data in the above database, that is, if the received BML data has already been received, the processing flow proceeds to step S34. On the other hand, if there is no reception record for the received BML data in the database and the received BML data is new data, the processing flow proceeds to step S35.

In step S34, BML data update determination section 310 reads a module_version included in a DII of the received BML data, references the above database, and determines whether or not that data has already been received. If there is a reception record for the received BML data in the above database, that is, if the received BML data has already been received, the received BML data is discarded and the processing flow returns to step S31. On the other hand, if there is no reception record for the received BML data in the database and the received BML data is new data, the processing flow proceeds to step S35.

As described above, if BML data received from received signal separation section 104 is new data, processing shifts to step S35.

In step S35, BML data update determination section 310 transmits BML data to BML data management section 110.

In step S36, BML data update determination section 310 updates the database holding BML data reception records, and returns to step S31.

Thus, digital broadcast reception apparatus 300 of this embodiment is provided with BML data update determination section 310 that determines whether or not data broadcast data separated from a digital broadcast is the latest, and if the data broadcast data is the latest, transmits the data broadcast data to BML data management section 110. BML data sent to BML data management section 110 can be limited, and the number of times BML data is stored in BML data storage section 111 and the number of times browser section 112 processing is performed can be reduced. By this means, a digital broadcast reception apparatus can be provided that displays a data broadcast screen quickly after a user requests data broadcast presentation, and that is highly effective in terms of power saving.

The above description presents examples of preferred embodiments of the present invention, but the scope of the present invention is not limited to these.

In these embodiments, the terms “digital broadcast reception apparatus” and “digital broadcast reception method” have been used, but this is simply for convenience of description, and the term “reception apparatus” or “digital broadcast reception terminal” may, of course, also be used for an apparatus, and a term such as “startup display control method” for a method.

The type, number, connection method, and so forth of sections—for example, a broadcast reception section and browser section—configuring an above-described digital broadcast reception apparatus may be of any kind.

An above-described digital broadcast reception method is implemented by means of a program for causing this digital broadcast reception method to function. This program is stored in a computer-readable storage medium.

The function blocks of a digital broadcast reception apparatus may also be implemented as LSIs, which are integrated circuits. These may be implemented individually as single chips, or a single chip may incorporate some or all of them. Here, the term LSI has been used, but the terms IC, system LSI, super LSI, and ultra LSI may also be used according to differences in the degree of integration.

The method of implementing integrated circuitry is not limited to LSI, and implementation by means of dedicated circuitry or a general-purpose processor may also be used. An FPGA for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The present invention has been described in detail and with reference to specific embodiments, but it will be clear to those skilled in the art that various variations and modifications may be possible without departing from the spirit and scope of the present invention.

The disclosure of Japanese Patent Application No. 2009-141290, filed on Jun. 12, 2009, including the specification, drawings and abstract, is incorporated herein by reference in its entirety.

### INDUSTRIAL APPLICABILITY

A digital broadcast reception apparatus and digital broadcast reception method according to the present invention are suitable for use in a digital broadcast reception apparatus capable of receiving digital broadcasting.

### REFERENCE SIGNS LIST

100, 200, 300 Digital broadcast reception apparatus
101 Antenna section
102 Channel selection section
103 Demodulation section
104 Received signal separation section
105 Audio signal processing section
106 Audio output section
107 Video signal processing section
108 Video/data combining section
109 Video output section
110 BML data management section
111 BML data storage section
112 Browser section
113 Layout control section
114 Screen holding section
115 Video position information holding section
210 BML data extraction section
310 BML data update determination section

1. A digital broadcast reception apparatus that is capable of receiving a data broadcast, the digital broadcast reception apparatus comprising:
a browser section that creates a data broadcast service presentation screen from data broadcast data;
a screen holding section that stores a picture of a data broadcast presentation screen created by the browser section;
a video position information holding section that stores position information for displaying television video in a data broadcast presentation screen created by the browser section; and
a layout control section that, when a data broadcast presentation request is received from a user, first displays a data broadcast presentation screen combining a picture of a data broadcast presentation screen stored in the screen holding section and position information stored in the video position information holding section, and then switches display to a data broadcast presentation screen created by the browser section after receiving a data broadcast presentation request from a user.

2. The digital broadcast reception apparatus according to claim 1, further comprising:
a broadcast markup language data storage section that stores data broadcast data separated from a digital broadcast wave; and
a broadcast markup language data management section that manages the data broadcast data and data broadcast data stored in the broadcast markup language data storage section,
wherein the broadcast markup language data management section switches between data broadcast data stored in the broadcast markup language data storage section and data broadcast data separated from a newly received digital broadcast wave, and sends data to the browser section.

3. The digital broadcast reception apparatus according to claim 2, wherein:
the browser section creates data broadcast presentation screen A based on data broadcast data stored in the broadcast markup language data storage section, and creates data broadcast presentation screen B based on data broadcast data newly received from the broadcast markup language data management section; and
the layout control section switches display sequentially between the data broadcast presentation screen A and the data broadcast presentation screen B.

4. The digital broadcast reception apparatus according to claim 2, further comprising a broadcast markup language data extraction section that extracts a procedure description language part from data broadcast data, and reconfigures data broadcast data based on an extracted procedure description language part, wherein:
the broadcast markup language data storage section stores the reconfigured data broadcast data; and
the broadcast markup language data management section switches between reconfigured data broadcast data stored in the broadcast markup language data storage section and data broadcast data separated from a newly received digital broadcast wave, and sends data to the browser section.

5. The digital broadcast reception apparatus according to claim 2, further comprising a broadcast markup language data update determination section that determines whether or not data broadcast data separated from a digital broadcast wave is the latest, wherein the broadcast markup language data update determination section, when the data broadcast data is the latest, sends data broadcast data to the broadcast markup language data management section.

6. A digital broadcast reception method that receives a data broadcast, the digital broadcast reception method comprising:
a step of creating a data broadcast service presentation screen from data broadcast data at predetermined update timing;
a step of storing a picture of a created data broadcast presentation screen;
a step of storing position information for displaying television video in a created data broadcast presentation screen; and
a step of, when a data broadcast presentation request is received from a user, first displaying a data broadcast presentation screen combining the data broadcast presentation screen picture and the position information stored prior to that data broadcast presentation request, and then switching display to a data broadcast presentation screen created after receiving that data broadcast presentation request.
